(19) United States
(12) Patent Application Publication
(10) Pub. No.: US 2013/0240132 A1
(43) Pub. Date: Sep. 19, 2013

(54) METHOD FOR MANUFACTURING A SUBSTRATE OF BLIND SLATS

(71) Applicant: Hsiao-Yin CHEN, New Taipei City (TW)

(72) Inventor: Hsiao-Yin CHEN, New Taipei City (TW)

(21) Appl. No.: 13/418,565

(22) Filed: Mar. 13, 2012

(51) Int. Cl. B32B 3/04

(52) U.S. Cl. 156/216

(57) ABSTRACT

A method for manufacturing a substrate of blind slats. A substrate is wrapped by a cladding material to form a slat substrate, which facilitates a post-processing to form a slat that can be applied to a blind. A side of the cladding material is coated with an adhesive agent and the cladding material is bended in advance by cold pressing to facilitate wrapping the substrate in the cladding material. Next, the cladding material is adhered with the substrate by hot melting. Accordingly, when a blind slat is formed after the slat substrate has been undergone with a post-processing, a natural and soft texture of the slat can be improved, a hard cold sense of metals can be decreased, as well as a danger of chemical substances can be reduced.

### BACKGROUND OF THE INVENTION

a) Field of the Invention

The present invention relates to a method for manufacturing a substrate of blind slats, and more particularly to a manufacturing method, wherein a cladding material is wrapped on a substrate to form a slat substrate, facilitating a post-processing to form the slats that can be applied to a blind.

b) Description of the Prior Art

A blind is currently used by every family or indoor space. The existing blind is mostly controlled by cords to expand or collect the blind.

The existing blind is assembled primarily by plural slats. Each slat is provided with plural through-holes, allowing cords to pass through these through-holes, so that the blind can be expanded or collected by the cords.

However, for most of the blinds on existing markets, the slats are constituted primarily by wood pieces, aluminum pieces and PVC (Polyvinyl Chloride) pieces.

The blind slats that are constituted by the abovementioned three materials are provided with following shortcomings:
1. The metallic sense is stronger and there is in short of the sense of nature.
2. As the blind slats are formed by chemicals, toxic ingredients can be easily produced once the slats are irradiated by sunlight directly.

As a result, under a long time of use, a user can inhale too many toxic substances which will be harmful to the user.

Accordingly, the present invention provides a method for manufacturing a substrate of blind slats, in order to improve the abovementioned problems.

### SUMMARY OF THE INVENTION

The primary object of the present invention is to provide a method for manufacturing a substrate of blind slats, in order to improve a natural and soft texture of the slats, decrease a hard cold sense of metals, as well as reduce a danger of chemical substances.

To achieve the aforementioned object, the present invention uses primarily a cladding material to wrap on a substrate, forming a slat substrate. A side of the cladding material is coated with an adhesive agent and the cladding material is bended in advance by cold pressing, so as to facilitate wrapping the substrate in the cladding material. Next, the cladding material is adhered with the substrate by hot melting.

Accordingly, after the slat substrate of the present invention has been undergone with a post-processing to form the slat, the natural and soft texture of the slat can be improved, the hard cold sense of metals can be decreased, as well as the danger of chemical substances can be reduced.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of manufacturing of the present invention.

FIG. 2 shows a schematic view of the present invention, wherein a cladding material is coated with an adhesive agent.

FIG. 3 shows a schematic view of the present invention, after cold press formation.

FIG. 4 shows a schematic view of the present invention, wherein a substrate is wrapped by the cladding material.

FIG. 5 shows a schematic view of the present invention, after the cladding material has been adhered with the substrate.

FIG. 6 shows a cut-away view of the present invention, after the cladding material has been adhered with the substrate.

FIG. 7 shows a schematic view of the present invention, wherein the slat substrate is used on a blind.

### DETAILED DESCRIPTION OF THE PREFERRED EMBODIMENTS

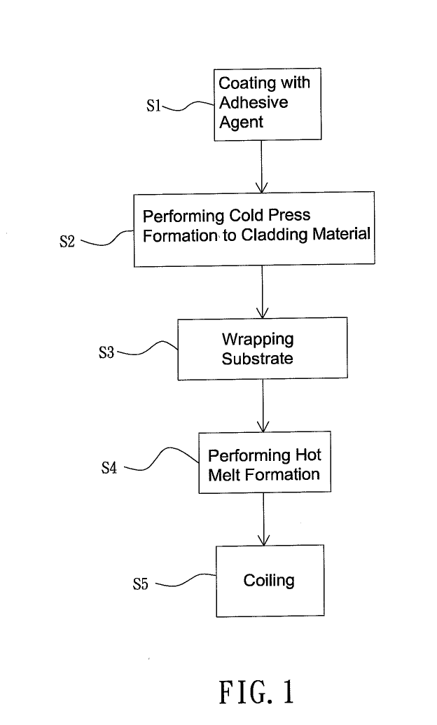

Referring to FIG. 1, it shows a flow diagram of manufacturing of the present invention. The method for manufacturing a substrate of blind slats, according to the present invention, comprises following steps:
1. Coating a cladding material with an adhesive agent S1: a side of a cladding material is coated with an adhesive agent.

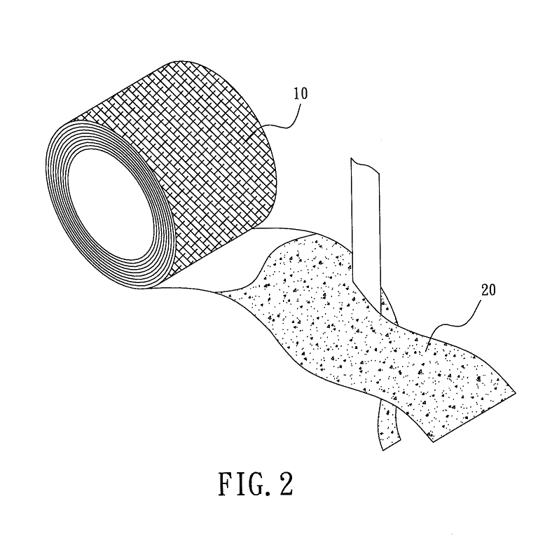

Referring to FIG. 2 at a same time, it shows a schematic view of the present invention, wherein a cladding material is coated with an adhesive agent. In the present invention, the cladding material 10 is a roll and a side of the cladding material 10 is coated with the adhesive agent 20. Next, the cladding material 10 is cut into a proper width, or, the width of the cladding material 10 is larger than that of the substrate (not shown in the drawing), such that the cladding material 10 can completely wrap the substrate. Of course, in a practical application, the cladding material 10 can be cut into the proper width before being coated with the adhesive agent 20.
2. Cold press formation S2: the cladding material that is coated with the adhesive agent is formed by cold pressing, allowing a left and right end of the cladding material to bend respectively with a pre-bending area toward the side that is coated with the adhesive agent, so as to form a

U-shaped groove at the side of the cladding material with the adhesive agent.

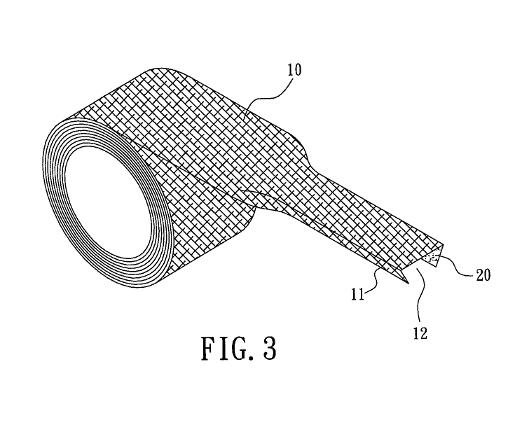

Referring to FIG. 3 at a same time, it shows a schematic view of the present invention after the cold press formation. As shown in the drawing, in the abovementioned cold press formation, the left and right side of the cladding material 10 are pressed and bended in advance toward the side of the cladding material 10 that is coated with the adhesive agent 20, allowing the two sides of the cladding material 10 to bend and form respectively with a pre-bending area 11, such that the cladding material 10 can be roughly in a U shape and a U-shaped groove 12 can be formed, with that the adhesive agent 20 is distributed on a surface of the U-shaped groove 12.
3. Wrapping a substrate S3: a substrate is put into the U-shaped groove of the cladding material, allowing the cladding material to wrap the substrate completely.

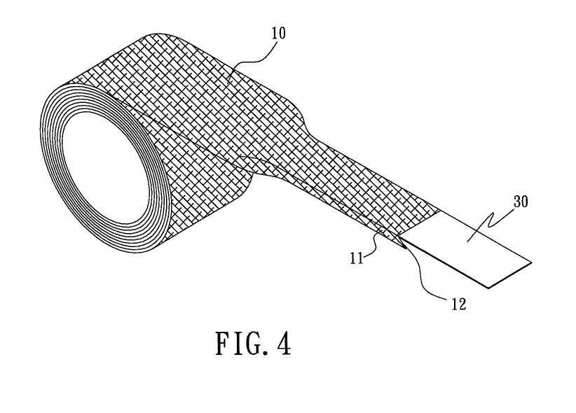

Referring to FIG. 4 at a same time, it shows a schematic view of the present invention, wherein the substrate is wrapped by the cladding material. As shown in the drawing, the substrate 30 is put into the U-shaped groove 12 of the cladding material 10, such that the bended pre-bending areas 11 at two sides of the cladding material 10 can be located at a back side of the substrate 30 to facilitate a subsequent post-processing.
4. Hot melt formation S4: the cladding material is adhered with the substrate with the adhesive agent by hot melting.

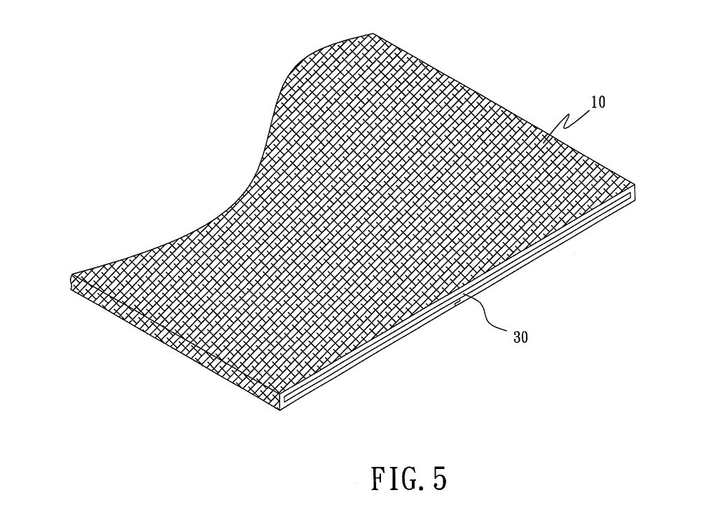

Referring to FIG. 5 at a same time, it shows a schematic view of the present invention, after the cladding material has been adhered with the substrate. As shown in the drawing, the cladding material 10 and the substrate 30 are rolled and heated at a high temperature, allowing the side of the cladding material 10 that is coated with the adhesive agent (not shown in the drawing) to be completely attached on peripheries of an outer surface of the substrate 30 to truly wrap the substrate 30.
5. Coiling S5: finally, the substrate that is wrapped by the cladding material is packed by coiling to facilitate transporting.

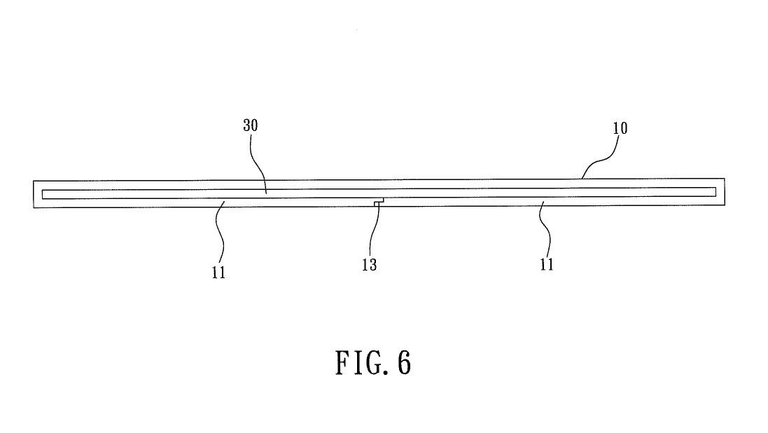

Referring to FIG. 5 and FIG. 6, it shows respectively the schematic view and a cut-away view of the present invention, after the cladding material has been adhered with the substrate. As shown in the drawings, when the cladding material 10 wraps the outer peripheries of the substrate 30, the width of the cladding material 10 is larger than that of the substrate 30, allowing the cladding material 10 to be truly attached on an exterior side of the substrate 30 with the adhesive agent (not shown in the drawings).

It is worth of mentioning that when the cladding material 10 wraps the exterior side of the substrate 30, the pre-bending areas 11 at two sides of the cladding material 10 are attached on the back side of the substrate 30 and an overlapping area 13 is formed on the back side of the substrate 30, so that through this overlapping area 13, the cladding material 10 can be truly attached on the exterior surface of the substrate 30 during the process of wrapping, thereby avoiding air bubbles to occur and enabling the cladding material 10 to be more tightly attached with the substrate 30.

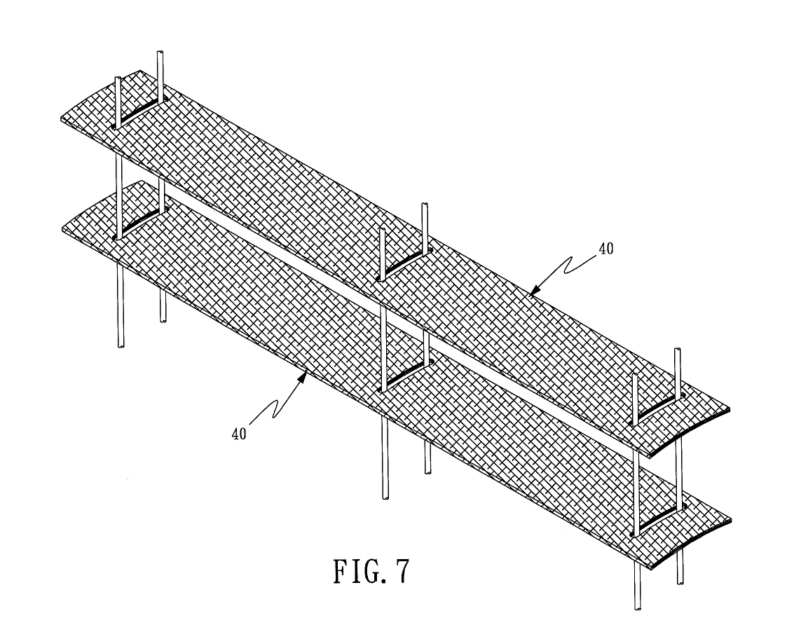

Finally, referring to FIG. 7, it shows a schematic view of the present invention, wherein the slat substrate is used on a blind. As shown in the drawing, the slat substrate is formed primarily by adhering a substrate 30 with a cladding material 10 using an adhesive agent (not shown in the drawing), as shown in FIG. 5. Therefore, when slats 40 are formed after the slat substrate has been undergone with the post-processing, for each slat 40, the surface of the substrate 30 is formed with the cladding material 10. As the cladding material 10 is cloth, an effect of blocking ultraviolet can be achieved, a natural and soft texture of the slat can be improved, a hard cold sense of metals can be decreased, as well as a danger of chemical substances can be reduced.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A method for manufacturing a substrate of blind slats, being used to wrap a substrate with a cladding material, the method comprising the steps of:
a) coating a side of the cladding material with an adhesive agent;
b) cold pressing the cladding material that is coated with the adhesive agent, allowing a left and right end of the cladding material to bend respectively with a pre-bending area toward the side of the cladding material that is coated with the adhesive agent, to form a U-shaped groove at a side of the cladding material that is coated With the adhesive agent;
c) putting a substrate into the U-shaped groove of the cladding material, and wrapping the cladding material around to the substrate completely;
d) heating and rolling the cladding material, after wrapping around the substrate, so as to be adhered with the substrate by hot melting of the adhesive agent.

2. The method for manufacturing a substrate of blind slats, according to claim 1, further including a step of coiling, wherein the substrate that is wrapped by the cladding material after hot melting is coiled for receiving.

3. The method for manufacturing a substrate of blind slats, according to claim 1, wherein the cladding material is cloth.

4. The method for manufacturing a substrate of blind slats, according to claim 2, wherein the cladding material is cloth.

5. The method for manufacturing a substrate of blind slats, according to claim 1, wherein a width of the cladding material is larger than that of the substrate.

6. The method for manufacturing a substrate of blind slats, according to claim 2, wherein a width of the cladding material is larger than that of the substrate.

7. The method for manufacturing a substrate of blind is slates, according to claim 1, wherein two pre-bending areas of the cladding material are adhered and attached on a back side of the substrate.

8. The method for manufacturing a substrate of blind slats, according to claim 2, wherein two pre-bending areas of the cladding material are adhered and attached on a back side of the substrate.
